(19) United States
(12) Patent Application Publication
(10) Pub. No.: US 2007/0083429 A1
(43) Pub. Date: Apr. 12, 2007

(54) Enabling contextually placed ads in print media

(76) Inventor: Reiner Kraft, Gilroy, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/248,738

(22) Filed: Oct. 11, 2005

(51) Int. Cl. G06Q 30/00

(52) U.S. Cl. 705/14

(57) ABSTRACT

Techniques for matching advertisements to articles are provided. According to one aspect, advertisements are automatically matched with to-be-published articles based at least in part on the concepts to which the advertisements and the articles pertain. The concepts to which the advertisements and the articles pertain are automatically determined so that no human intervention is required. The matching advertisements and articles are placed proximately to each other in a printed publication. As a result, when the articles are published, advertisements that relate to at least some of the concepts to which the articles pertain are seen next to those articles. This contextual advertisement positioning increases readers' interest in the advertisements, and helps to promote revenues for both advertisers and publishers.

### FIELD OF THE INVENTION

The present invention relates to data processing and, more specifically, to effectively placing advertisements proximate to printed publications' articles that contextually match the advertisements.

### BACKGROUND

Although the Internet is a pervasive means of communicating information, it is not by any stretch of the imagination the exclusive means of doing so. The Internet has not completely replaced newspapers and magazines, for example, as a vehicle for conveying content to people. Those who wish to purvey content to large groups of others still often find traditional media to be an effective way of reaching an intended audience.

Advertisers place advertisements in newspapers and magazines in hopes of making potential buyers or clients aware of the advertisers' products and/or services. In placing advertisements in printed publications such as newspapers and magazines, advertisers hope that readers of the printed publications will see the advertisements and want to buy the products or services advertised. Typically, the publisher of the printed publication charges advertisers fees in exchange for placing the advertisers' advertisements in the printed publication. Such fees help to defray the costs of printing and distributing the publication.

In some cases, an advertiser gives its advertisements to a publisher in advance of the time that the publication goes to the printer. The publisher determines where, in the publication, the advertisements will fit, and puts the advertisements in those places. Thus, the placement of the advertisements is almost entirely at the publisher's discretion.

The publisher should be motivated to position the advertisements in a manner that will give maximum benefit to the advertiser, so as to encourage the advertiser to continue advertising in the publication. However, all too often, the advertisements placed next to the publisher's written material on a particular page of the publication have little or nothing to do with that written material. As a result, readers interested in the publisher's written material are often uninterested in the products or services advertised next to that written material. The advertiser's sales are not boosted by the advertisement. The advertiser may think twice before placing advertisements in the publication again.

These are not the only difficulties that attend the world of advertising. A publisher usually needs to employ people to handle the placement of advertisements in a publication. The publisher might need to employ people to solicit business from advertisers. Employing people to perform these tasks can cost the publisher a considerable amount of money. If the people do not do their jobs well, the costs to the publisher can be even greater.

A better way of placing advertisements in printed publications is needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates an example of a technique for automatically matching advertisements with to-be-published articles, according to an embodiment of the invention; and

FIG. 2 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to one embodiment of the invention, advertisements are automatically matched with to-be-published written materials, such as articles, based at least in part on the concepts to which the advertisements and the written materials pertain. As used herein, the word “concept” refers to topics, ideas, subjects, phrases, etc. The concepts to which the advertisements and the written materials pertain are automatically determined so that no human intervention is required. The matching advertisements and written materials are placed proximately to each other in a printed publication. As a result, when the written materials are published, advertisements that relate to at least some of the concepts to which the written materials pertain are seen next to those written materials. This contextual advertisement positioning increases readers' interest in the advertisements, and helps to promote revenues for both advertisers and publishers.

### Automatically Matching Advertisements to Articles

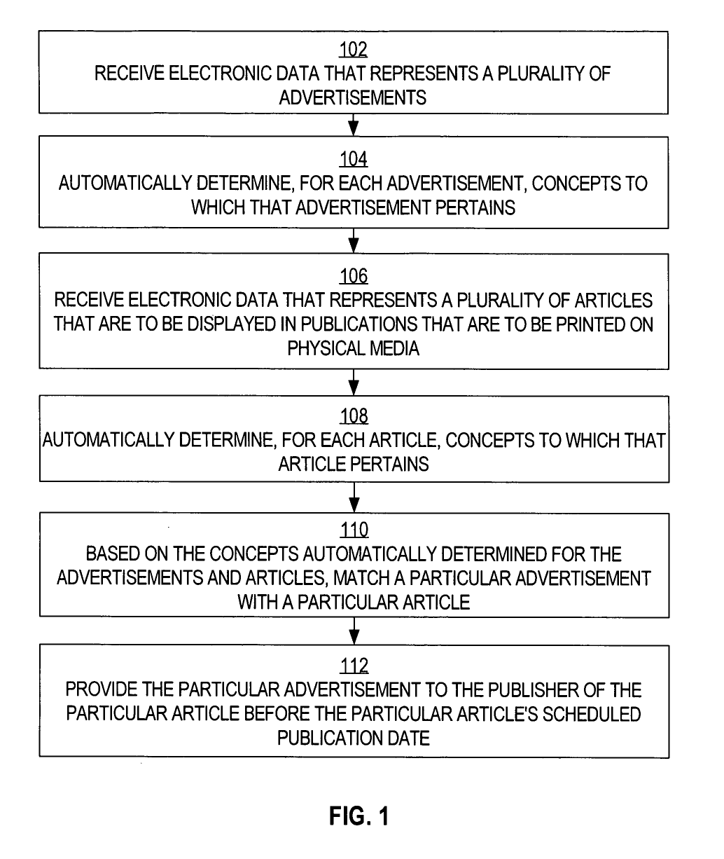

FIG. 1 is a flow diagram that illustrates an example of a technique for automatically matching advertisements with to-be-published articles, according to an embodiment of the invention. As used herein, the word “article” is defined as “a body of text.” Typically, an article comprises two or more words. The technique described below may be performed at least in part by a process executing on a service provider's computer, such as the computer described below with reference to FIG, 2, for example. As used herein, a “service provider” is a person, organization, etc. Although the steps of the technique are presented in a particular order, embodiments of the invention are not limited by the order in which the steps are performed.

In block 102, electronic data that represents a plurality of advertisements is received at a service provider's computer. For example, a process executing on a service provider's computer may receive such electronic data from an advertiser's computer. The electronic data may be submitted to the process as attachments to e-mail or through a web browser-interpreted form, for example. The service provider may run a web server that transmits, to the advertiser's web browser, a web page that contains a form through which the advertiser can upload the electronic data to the service provider's computer, for example. Thus, the electronic data may flow from the advertiser to the service provider's computer via the Internet.

In block 104, for each advertisement of the plurality of advertisements, the service provider's computer automatically determines, based at least in part on contents of that advertisement, one or more concepts to which that advertisement pertains. For example, a process executing on the service provider's computer may perform a textual analysis of an advertisement, which typically comprises multiple words. The result of the textual analysis is a set of concepts to which the advertisement pertains.

There are many ways in which such a textual analysis can be performed. In one embodiment of the invention, key concepts within the advertisement are automatically determined using a technique described in U.S. patent application Ser. No. 10/903,283, titled “SEARCH SYSTEMS AND METHODS USING IN-LINE CONTEXTUAL QUERIES,” the contents of which patent application are incorporated by reference in their entirety for all purposes, as though originally disclosed herein. Essentially, that technique selects terms of relatively high importance from a body of text, where each term comprises one or more words. At least some of these terms are placed into a “context vector” for the body of text. The context vector may contain other useful information about the selected terms, such as the number of times that each term occurs in the body of text, for example. In one embodiment of the invention, terms are selected based on how many times that those terms occur in the body of text; terms which occur most often are selected. The context vector represents the main concepts to which the body of text pertains.

In block 106, electronic data that represents a plurality of articles, which are to be displayed in one or more publications that are to be printed on physical media, is received at a service provider's computer. As used herein, “physical media” includes paper, sheets of plastic, cloth, wood, fabric, etc.—basically, any material upon which words can be visibly written, printed, stamped, engraved, or otherwise fixed.

For example, a process executing on the service provider's computer may receive such electronic data from a newspaper or magazine publisher's computer. The electronic data may be submitted to the process as attachments to e-mail or through a web browser-interpreted form, for example. The service provider's web server may transmit, to the publisher's web browser, a web page that contains a form through which the publisher can upload the electronic data to the service provider's computer, for example. Thus, the electronic data may flow from the publisher to the service provider's computer via the Internet.

In block 108, for each article of the plurality of articles, the service provider's computer automatically determines, based at least in part on contents of that article, one or more concepts to which that article pertains. For example, the process executing on the service provider's computer may perform a textual analysis of an article in the same manner that the process performs a textual analysis of an advertisement, as described above with reference to block 104. The result of the textual analysis is a set of concepts to which the article pertains.

In block 110, based at least in part on (a) an automatically determined concept to which a particular advertisement of the plurality of advertisements pertains, and (b) an automatically determined concept to which a particular article of the plurality of articles pertains, the particular advertisement is matched to the particular article. For example, after determining the key concepts for advertisements and articles submitted to the service provider as described above with reference to blocks 104 and 108, the process executing on the service provider's computer may match advertisements to articles based at least in part on how many key concepts are shared between the advertisements and articles. An advertisement that has many key concepts in common with an article may be matched to that article. Thus, the process may automatically establish mappings between advertisements and articles.

For example, an advertisement might pertain to key concepts “video game,” “game,” “first-person,” and “personal computer.” An article might pertain to key concepts “video game,” “game,” “personal computer,” and “Bay Area.” Based on the shared key concepts of “video game,” “game,” and “personal computer,” the process might match the advertisement to the article. In one embodiment of the invention, if an advertisement matches more than one article, then the process matches the advertisement only to the article with which the advertisement shares the most key concepts.

Other criteria, beyond similarities in key concepts, may be used to determine which advertisements should be matched to which articles. Some of these criteria are described in further detail below.

In block 112, in response to the particular advertisement being matched to the particular article, the particular advertisement is provided to a prospective publisher of the particular article before a time that the particular article is scheduled to be published. For example, the process executing on the service provider's computer may automatically generate an e-mail message that is addressed to a newspaper or magazine publisher that submitted the particular article in block 106. Before sending the e-mail message, the process may attach, to the e-mail message, electronic data that represents one or more advertisements that match articles that the publisher submitted to the service provider. The e-mail message may inform the publisher which of the attached advertisements match which of the publisher's articles.

When the publisher receives the matching advertisement data from the service provider, the publisher may then arrange the layout of the pages of his prospective publication so that the advertisements that match a particular article are displayed in close proximity to the particular article. For example, prior to printing a magazine or newspaper for mass distribution, a newspaper or magazine publisher may arrange the layout of the pages of the newspaper or magazine so that advertisements that match a particular article in the newspaper or magazine are adjacent to the particular article, or at least on the same page or a facing page.

Later, after the newspaper or magazine has been printed and distributed, readers will find that the advertisements that they see next to articles pertain to the same topics as the articles do. As a result, the readers are more likely to be interested in the advertisements, and are more likely to pursue the products and/or services advertised therein.

### Additional Criteria Used for Matching

As is described above, in one embodiment of the invention, the key concepts of advertisements and articles are automatically determined, and then advertisements and articles are matched with each other based on the extent to which they share key concepts. However, in one embodiment of the invention, before an advertisement can be matched with an article, additional criteria associated with the advertisement and/or the article must be satisfied.

In one embodiment of the invention, each advertiser that wants to have its advertisements automatically placed by the service provider establishes an account with the service provider. Account establishment, and virtually all interaction with the service provider, may be accomplished via automated web page forms transmitted between the service provider's web server and the other entity's web browser via the Internet, for example. Thus, no human needs to be involved on the service provider's side. Similarly, each publisher that wants to include contextually matching advertisements next to the articles in its publication establishes an account with the service provider.

Along with a batch of one or more advertisements, an advertiser submits associated criteria to the service provider. In one embodiment of the invention, the advertiser-submitted criteria indicate the regions in which the advertiser would like the advertisements in the batch to be seen. Regions may be identified by zip code, for example.

In one embodiment of the invention, the service provider maintains a list of associations between regions and publishers that distribute publications to those regions. For example, for a particular region, the service provider may maintain, in a database, an association between the particular region and one or more newspapers and/or magazines that are distributed to that region.

In one embodiment of the invention, after the advertiser submits a list of one or more regions of interest to the service provider, the service provider responds with a list of publications that are associated with those regions. Along with each publication, the list may indicate a description of the target audience for that publication, the estimated readership of the publication, and/or other relevant publication information. The advertiser may then select one or more publications from that list, and submit a list of advertiser-selected publications back to the service provider. The service provider establishes an association between the batch of advertisements and the list of selected publications.

In one embodiment of the invention, the advertiser-submitted criteria indicate a date by which the advertisements in the batch must be published. For example, the advertiser may indicate that each advertisement in the batch must be printed in an edition of a publication that is published and distributed no later than a specified date. The service provider establishes an association between the batch of advertisements and the specified date.

In one embodiment of the invention, for each advertisement in the batch, the advertiser indicates the size of that advertisement (e.g., in inches by inches, words, etc.) and whether or not that advertisement includes an image. The service provider establishes an association between each advertisement and the indicated characteristics of that advertisement.

In one embodiment of the invention, the advertiser-submitted criteria indicate a maximum dollar amount that the advertiser is willing to pay to have its advertisements published. The service provider establishes an association between the batch of advertisements and the specified dollar amount.

In one embodiment of the invention, each publisher that establishes an account with the service provider also submits, to the service provider, a set of one or more criteria that the service provider associates with the publisher, or with the publisher's publication (some publishers may have multiple publications). A publisher may submit such criteria to the service provider at the time that the publisher establishes an account. Additionally or alternatively, a publisher may submit or alter such criteria at times of the publisher's choosing. For example, a publisher may submit different criteria to the service provider each time that the publisher expects to be printing a new edition of its publication in the near future. In one embodiment of the invention, the most recent publisher-submitted criteria apply to all articles in the next edition of the publisher's publication.

In one embodiment of the invention, at the time that a publisher establishes an account with the service provider, the publisher submits, to the service provider, the names of the publications that the publisher publishes, and the regions in which each of those publications are distributed. The regions may be indicated by zip code, for example. Along with each publication, the publisher may indicate a description of the target audience for that publication, the estimated readership of the publication, and/or other relevant publication information. For each publication, the service provider maintains an association between that publication, the regions to which that publication is distributed, and the other descriptive publisher-submitted information. These associations serve as the basis for determining lists of publications that the service provider sends to advertisers, as described above.

In one embodiment of the invention, some time prior to printing a new edition of a publication, a publisher submits, to the service provider, a batch of one or more articles that the publisher intends to include in the new edition. The service provider may require that the submission of a batch of articles occur at least a specified amount of time prior to the time that the new edition will be printed. Along with the batch of articles, the publisher indicates, to the service provider, a date on which the publisher is going to send the new edition to the printer. The publisher also may indicate, to the service provider, a date by which the publisher needs to obtain, from the service provider, the matching advertisements that the publisher will place next to the articles in the new edition. The service provider establishes an association between the batch of articles and the dates discussed above.

In one embodiment of the invention, for each article in the batch of articles, the publisher indicates the minimum and/or maximum sizes of advertising spaces that are associated with that article (e.g., in inches by inches, words, etc.) and whether or not the advertisements placed in those advertising spaces are allowed to contain images. The service provider establishes an association between each article and the indicated characteristics of the advertising spaces associated with that article.

In one embodiment of the invention, the publisher-submitted criteria indicate a minimum dollar amount that the publisher is willing to accept to print advertisements in a publication. The amount may be per edition of the publication. Alternatively, the publisher may specify a custom minimum dollar amount for each article that the publisher submits to the service provider. The dollar amount may be specified per word, letter, line, or per square inch in a prospective matching advertisement, for example. The service provider establishes an association between the articles in the batch of articles and the specified dollar amounts.

In one embodiment of the invention, when the service provider's process automatically matches advertisements to articles, it takes into account the criteria that are associated with those advertisements and articles. For example, in one embodiment of the invention, when determining which article best matches an advertisement, the process first eliminates from consideration all articles that will not be published prior to the date on which advertisement is supposed to be published. From the remaining candidate articles, the process eliminates all articles that will not be published in regions in which the advertisement is supposed to be published. If any of the advertising spaces associated with the remaining candidate articles are smaller than the specified size of the advertisements, or if any of those advertising spaces do not allow images in cases where the advertisement contains an image, then the articles associated with those advertising spaces are removed from consideration as well. From the remaining candidate articles, the process eliminates all articles that are associated with a minimum dollar amount that is larger than the maximum dollar amount that is associated with the advertisement. Once this filtering has been performed, the candidate article that shares the most key concepts with the advertisement may be matched with the advertisement.

### Flexibilty Constraints

In one embodiment of the invention, the advertiser can specify, to the service provider, an extent of strictness with which the advertiser's specified criteria must be met by candidate articles. For example, the advertiser can specify that candidate articles that are within the advertiser-specified regions are preferred, but that the advertiser will allow its advertisements to be printed proximate to articles published outside of the specified regions if there is not a suitable quantity of matching candidate articles in the specified regions. In one embodiment of the invention, the advertiser can specify an extent of strictness with respect to each criterion that the advertiser submits to the service provider. The service provider's process takes into account these extents when matching advertisements and articles as described above. If the strictness of an extent associated with a particular criterion is relatively low, then the process may refrain from excluding candidate articles that do not satisfy that criterion, especially if the number of contextually matching candidate articles would otherwise be below a specified threshold.

### Publisher Selection of Ranked Advertisements

In one embodiment of the invention, for each article that a publisher submits to the service provider, the service provider's process determines an extent to which each advertisement of a plurality of advertisements matches that advertisement, based at least in part on the criteria discussed above. The process assigns a score to each advertisement based on the extent to which that advertisement matches the article.

Prior to the time that the publisher is schedule to print the articles in the publication, the process sends, to the publisher, a list of advertisement that could be published next to each article, ordered based on the assigned scores. For example, the process may automatically e-mail such a list to the publisher's specified e-mail address. The publisher may then select one or more advertisements from among the listed advertisements, and inform the service provider of the selection via electronic means. The service provider may then electronically transmit the selected advertisements to the publisher ahead of the date that the publisher sends the publication to the printer.

### Expressly Specified Key Concepts

As is discussed above, in one embodiment of the invention, the service provider's process matches advertisements to articles based at least in part on the extent to which automatically determined key concepts in the advertisements match automatically determined key concepts in the articles. Typically, a computer-executed process determines these key concepts; no human interaction is involved.

However, in one embodiment of the invention, when an advertiser submits an advertisement to the service provider as described above, the advertiser also specifies one or more key concepts that may or may not be in the actual text of the advertisement. These key concepts may be terms that the service provider's process otherwise would not automatically select. The service provider associates these expressly specified concepts with the advertisement.

In such an embodiment of the invention, when the service provider's process automatically matches an advertisement with articles, the process performs the matching based not only on the concepts to which the advertisement was automatically determined to pertain, but also on the concepts that were expressly specified by the advertiser. It is as if the process determined the specified concepts to be among the automatically determined concepts associated with the advertisement. This helps an advertiser target certain articles and publications without having to modify the wording of the advertisement.

### Billing

In one embodiment of the invention, the advertiser and/or publisher agree to pay the service provider a specified dollar amount in exchange for the service provider's services. For example, an advertiser may agree to pay the service provider a specified dollar amount for each of the advertiser's advertisements that the service provider sends to a publisher. For another example, a publisher may agree to pay the service provider a specified dollar amount for each advertisement that the service provider sends to the publisher. These are but some examples of monetarily compensatory arrangements. Other arrangements are possible. Embodiments of the invention are not limited to any particular arrangement.

In one embodiment of the invention, after an aspect of an arrangement has been satisfied (e.g. the service provider has sent an advertisement to a publisher), a process executing on the service provider's computer automatically bills a specified amount to the appropriate advertiser's and/or publisher's account. Each advertiser account and publisher account may be associated with a separate “amount owed.” The service provider may periodically send bills to the account owners based on the amounts owed as specified in the respective accounts. Thus, the techniques described above may be made profitable to the service provider.

### Hardware Overview

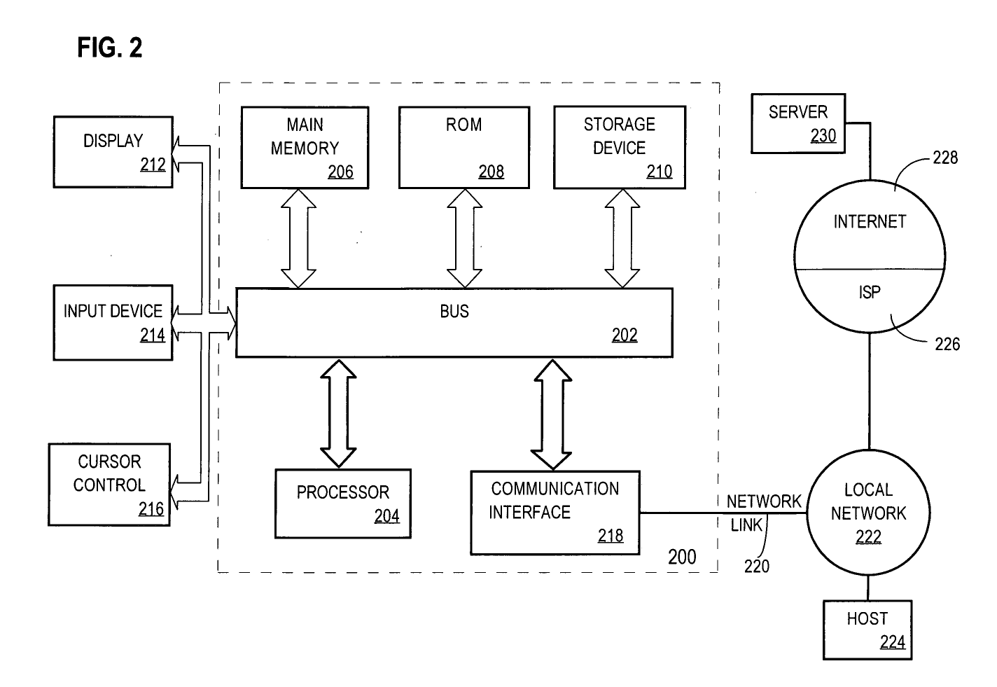

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating, direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 200, various machine-readable media are involved, for example, in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of assisted advertising, the method comprising:
receiving, at a computerized system, electronic data that represents a plurality of advertisements;
for each advertisement of the plurality of advertisements, the computerized system automatically determining, based at least in part on contents of that advertisement, one or more concepts to which that advertisement pertains;
receiving, at the computerized system, electronic data that represents a plurality of articles that are to be displayed in one or more publications that are to be printed on physical media;
for each article of the plurality of articles, the computerized system automatically determining, based at least in part on contents of that article, one or more concepts to which that article pertains;
based at least in part on (a) an automatically determined concept to which a particular advertisement of the plurality of advertisements pertains, and (b) an automatically determined concept to which a particular article of the plurality of articles pertains, matching the particular advertisement to the particular article; and
in response to the particular advertisement being matched to the particular article, providing the particular advertisement to a prospective publisher of the particular article before a time that the particular article is scheduled to be published.

2. The method of claim 1, further comprising:
receiving, at the computerized system, an indication of a first date on which the particular article is going to be published;
receiving, at the computerized system, an indication of a second date by which the particular advertisement needs to be published; and
wherein the step of matching the particular advertisement to the particular article comprises matching the particular advertisement to the particular article based at least in part on whether the first date is later than the second date.

3. The method of claim 1, further comprising:
receiving, at the computerized system, an indication of one or more first regions in which the particular article is going to be published;
receiving, at the computerized system, an indication of one or more second regions in which the particular advertisement needs to be published; and
wherein the step of matching the particular advertisement to the particular article comprises matching the particular advertisement to the particular article based at least in part on whether the one or more second regions are contained in the one or more first regions.

4. The method of claim 1, further comprising:
receiving, at the computerized system, an indication of a first size of an advertising space that is associated with the particular article;
receiving, at the computerized system, an indication of a second size of the particular advertisement; and
wherein the step of matching the particular advertisement to the particular article comprises matching the particular advertisement to the particular article based at least in part on whether the first size is larger than the second size.

5. The method of claim 1, further comprising:
receiving, at the computerized system, an indication of a first monetary amount that is a publisher want to charge for placing an advertisement next to the particular article;
receiving, at the computerized system, an indication of a second monetary amount that an advertiser is willing to pay to have the particular advertisement published; and
wherein the step of matching the particular advertisement to the particular article comprises matching the particular advertisement to the particular article based at least in part on whether the first monetary amount is less than the second monetary amount.

6. The method of claim 1, further comprising:
receiving, at the computerized system, an indication of a first extent to which articles need to satisfy criteria that are associated with the particular advertisement;
wherein the step of matching the particular advertisement to the particular article comprises determining a second extent to which the particular article satisfies the criteria that are associated with the particular advertisement; and
wherein the step of matching the particular advertisement to the particular article comprises determining whether the second extent is greater than the first extent.

7. The method of claim 1, further comprising:
providing, to the prospective publisher of the particular article, a list of advertisements from the plurality of advertisements; and
wherein the list is ranked based on scores assigned to advertisements in the list; and
wherein the scores assigned to advertisements in the list are based at least in part on extents to which the advertisements in the list match the particular article.

8. The method of claim 1, further comprising:
receiving, at a computerized system, electronic data that represents one or more concepts that are not expressed by words in the particular advertisement; and
wherein the step of matching the particular advertisement to the particular article is based at least in part on the one or more concepts.

9. The method of claim 1, further comprising:
after providing the particular advertisement to the prospective publisher, automatically adjusting a monetary amount that is associated with an entity, wherein the entity is one of (a) the prospective publisher and (b) an advertiser from which the particular advertisement was received.

10. The method of claim 1, wherein the one or more publications comprise a periodically published publication that is one of (a) a newspaper and (b) a magazine.

11. A computer-readable medium carrying one or more sequences of instructions which, when executed by one or more processors, causes the one or more processors to perform the method recited in claim 1.

12. A computer-readable medium carrying one or more sequences of instructions which, when executed by one or more processors, causes the one or more processors to perform the method recited in claim 2.

13. A computer-readable medium carrying one or more sequences of instructions which, when executed by one or more processors, causes the one or more processors to perform the method recited in claim 3.

14. A computer-readable medium carrying one or more sequences of instructions which, when executed by one or more processors, causes the one or more processors to perform the method recited in claim 4.

15. A computer-readable medium carrying one or more sequences of instructions which, when executed by one or more processors, causes the one or more processors to perform the method recited in claim 5.

16. A computer-readable medium carrying one or more sequences of instructions which, when executed by one or more processors, causes the one or more processors to perform the method recited in claim 6.

17. A computer-readable medium carrying one or more sequences of instructions which, when executed by one or more processors, causes the one or more processors to perform the method recited in claim 7.

18. A computer-readable medium carrying one or more sequences of instructions which, when executed by one or more processors, causes the one or more processors to perform the method recited in claim 8.

19. A computer-readable medium carrying one or more sequences of instructions which, when executed by one or more processors, causes the one or more processors to perform the method recited in claim 9.

20. A computer-readable medium carrying one or more sequences of instructions which, when executed by one or more processors, causes the one or more processors to perform the method recited in claim 10.
